(19) United States
(12) Patent Application Publication
(10) Pub. No.: US 2012/0006657 A1
(43) Pub. Date: Jan. 12, 2012

(54) LOW FRICTION V-BELT DRIVEN CURVE CONVEYOR

(75) Inventors: John M. Karas, Grand Rapids, MI (US); Floyd W. Butler, Newaygo, MI (US); Bruce E. Taylor, Morley, MI (US)

(73) Assignee: Dematic Corp., Grand Rapids, MI (US)

(21) Appl. No.: 13/175,524

(22) Filed: Jul. 1, 2011

Related U.S. Application Data
(60) Provisional application No. 61/363,011, filed on Jul. 9, 2010.

(51) Int. Cl. B65G 13/07

(52) U.S. Cl. 198/790

(57) ABSTRACT

A conveyor having at least one curved portion includes a pair of spaced apart side channels that are curved at the curved portion of the conveyor. A plurality of rollers are supported between the side channels. An endless drive member, which is propelled by a motor, drives the rollers. A guide system made up of a plurality of guide members guides the drive member. Each of the guide members includes a guide surface that provides substantial non-slip engagement with the drive member.

### CROSS-REFERENCE TO RELATED APPLICATION

This application claims priority from U.S. provisional patent application Ser. No. 61/363,011, filed on Jul. 9, 2010, the disclosure of which is hereby incorporated herein by reference in its entirety.

### BACKGROUND OF THE INVENTION

The present invention is directed to a powered conveyor and in particular to a powered conveyor having a curved portion, also known as a turn. While the invention is illustrated as a powered roller conveyor, it may find application in powered belt-on-roller conveyors and the like.

Various techniques are used to propel a conveying surface. One such technique is to provide an endless drive member, such as an endless belt, that is biased against rollers and propel that drive member with a motor. Propelling a conveying surface with an endless drive member at a curve requires that the drive member be guided around the curve while maintaining a biasing force biasing the drive member against the surface being driven, such as a roller surface. It is common to use some form of sheave, or pulley, to guide an endless drive member and bias the member against the driven rollers. The endless drive belt may be of various shapes, such as round belts, V-belts, rectangular belts, and the like. The drive belt often includes reinforcing fibers in order to provide sufficient strength to withstand the load placed on the belt. Such belts typically come preformed in standard lengths.

### SUMMARY OF THE INVENTION

Conventional belt-driven curve conveyors are limited in length by the standard length of the drive belts. The drive belt is typically reinforced to withstand the friction encountered with the guide sheaves, or pulleys. As the drive belt passes over the sheave, there is a wiping, or scrubbing, action between the sides of the belt and the sides of the pulley as the belt enters and exits the pulley that causes friction between the belt and sheave. This added friction increases the size of the horsepower needed to drive the belt. This increase in horsepower applied to the belt, in turn, dictates the necessity for a relatively strong reinforced vulcanized rubber belt to resist wear and breakage.

A conveyor having at least one curved portion, according to an aspect of the invention, includes a pair of spaced apart side channels that are curved at the curved portion of the conveyor. A plurality of rollers are supported between the side channels. An endless drive member, which is propelled by a motor, drives the rollers. A guide system made up of a plurality of guide members guides the drive member. Each of the guide members includes a guide surface that provides substantial non-slip engagement with the drive member.

This may be accomplished by the contact being substantially rolling contact. Such rolling contact may be a result of radius contact along a line at the surface of a cylinder. The drive member may have a generally planar surface with the guide surface providing the substantially non-slip engagement with the generally planar surface.

Each of the guide members may be in the form of a cylinder having a generally planar outer surface. The cylinder rotates about an axis that is generally parallel to the generally planar surface of the drive member. The axis may be angled toward an inside radius of the curved portion in the direction of the rollers. In this manner the drive member is biased against the rollers. The cylindrical members may be bearing members.

The endless drive member may be made substantially from a polymeric material. The drive member may be capable of weld-joining or splicing to allow virtually any length to be used. The polymeric material may be a urethane or polyester. The drive member may be in the form of a V-shaped belt. The rollers may be tapered rollers. Brackets may be provided to support the guide members from one of the side channels, namely, the sidewall at the inside radius of the curved portion. The brackets may provide cantilevered support for the guide members.

A conveyor having at least one curved portion, according to another aspect of the invention includes a pair of spaced apart side channels. The side channels are curved at the curved portion. A plurality of rollers are supported between the side channels. An endless drive member drives the rollers. A motor propels the drive member. A guide system guides the drive member. The guide system is made up of a plurality of guide members engaging the drive member. Each of the guide members is a rotatable cylindrical member.

These and other objects, advantages and features of this invention will become apparent upon review of the following specification in conjunction with the drawings.

### BRIEF DESCRIPTION OF THE DRAWINGS

FIG. 1 is a perspective view of a conveyor, according to an embodiment of the invention, as viewed from below the conveying surface;

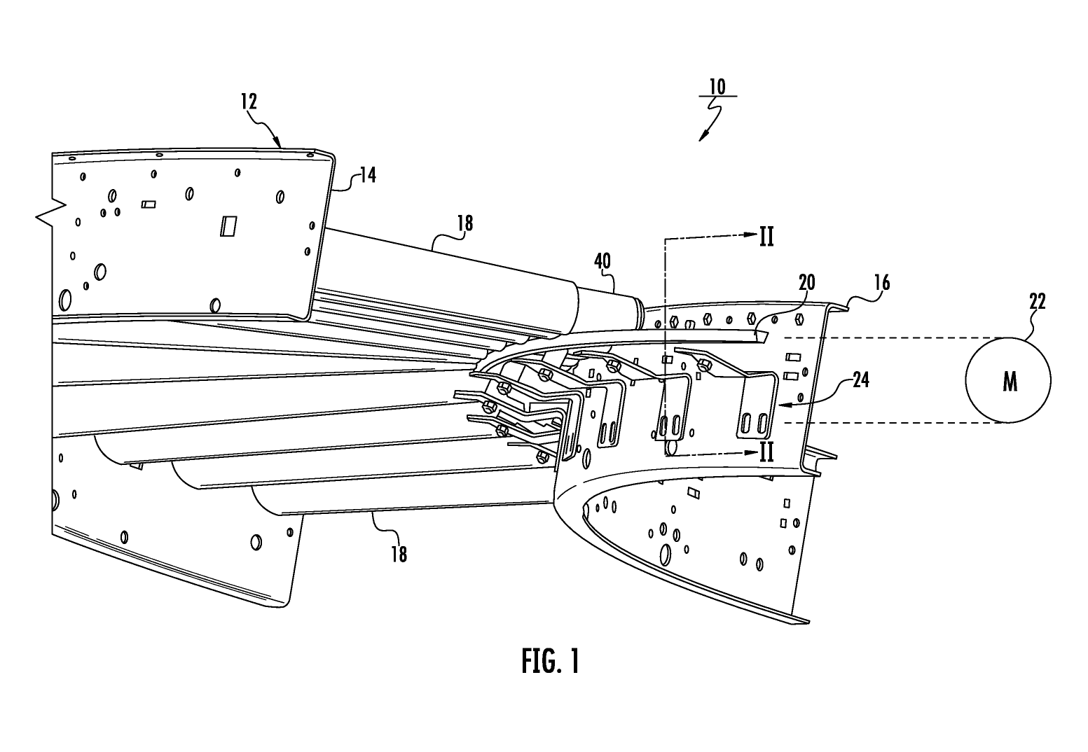

FIG. 2 is a sectional view taken along the lines in FIG. 1;

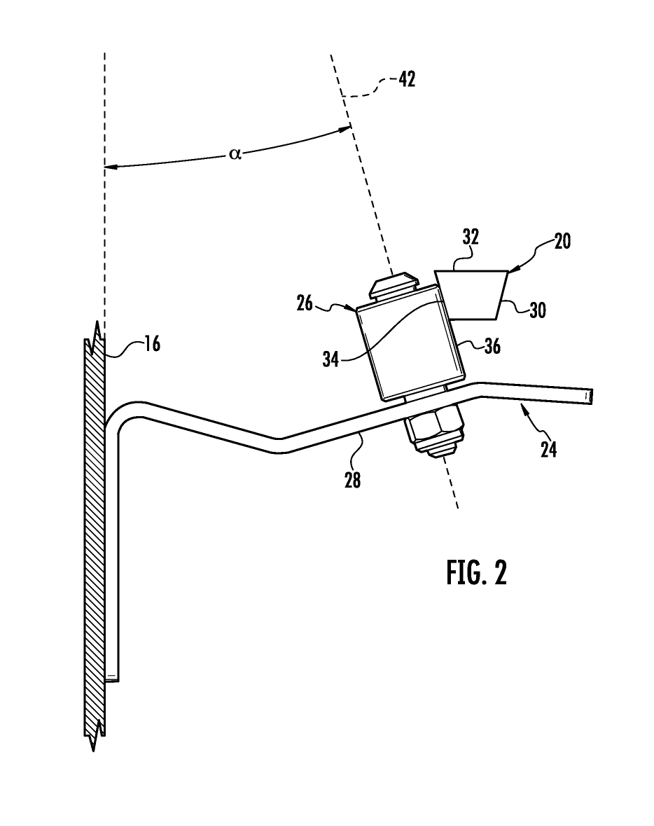

FIG. 3 is the same view as FIG. 2 of an alternative embodiment thereof;

FIG. 4 is the same view as FIG. 1 of an alternative embodiment thereof;

FIG. 5 is a perspective view of the conveyor in FIG. 4 as viewed from above the conveying surface; and

FIG. 6 is a perspective view of another alternative embodiment of a guide system.

### DESCRIPTION OF THE PREFERRED EMBODIMENT

Referring now to the drawings and the illustrative embodiments depicted therein, a conveyor 10 has at least one curved portion 12. In the illustrated embodiment, the entire conveyor is curved, which is known as a turn conveyor. However, curved portion 12 may be part of a larger conveyor having straight portions, other curved portions, or the like. Conveyor 10 includes a pair of spaced apart side channels that are curved, including an outside radius curved side channel 14 and an inside radius curved side channel 16. A plurality of freely rotating rollers 18 are supported between side channels 14, 16. An endless drive member 20 is provided to drive rollers 18. Although only an upper run of the drive member is illustrated, it is understood that a lower return run (not shown) is also provided. Drive member 20, which is illustrated as a V-belt, has a generally planar first surface 32 that engages rollers 18 to drive the rollers and one or more generally planar second surface 34. A motor 22 propels endless drive member 20. Motor 22 may be electrical, hydraulic, pneumatic or the like. In the illustrated embodiment, rollers 18 are tapered rollers having an outer surface that tapers from a larger radius adjacent outside radius side channel 14 to a narrower radius adjacent inside radius side channel 16. Such rollers are conventional and may include a constant radius portion 40 that is engaged by first surface 32 of drive member 20.

A guide system 24 is provided for guiding drive member 20. Guide system 24 includes a plurality of guide members 26, each of which may be supported by a bracket 28 to inside radius side channel 16. In the illustrated embodiment, brackets 28 provide cantilevered support for guide members 26. However, other bracket configurations could be used.

Each guide member 26 includes a guide surface 36 that provides substantial non-scrubbing engagement with generally planar second surface 34 of drive member 20. In particular, contact between surfaces 34, 36 is at a line that extends along a radius of guide surface 36. Each guide member 26 is in the form of a cylinder having a generally planar outer surface that defines guide surface 36 and which rotates about an axis 42 that is generally parallel to generally planar second surface 34 of drive member 20. This produces a low-friction interface between guide members 26 and drive member 20 because the drive member engages the guide member only at the radius of guide surface 36. This eliminates the rubbing/wiping/scrubbing action that can occur between a V-shaped belt and the sides of a sheave or pulley. Because of the low-friction interface between guide members 26 and drive member 20, there is less power wasted at each interface between a guide member 26 and drive member 20. In this fashion, more of the power supplied by motor 22 is directed toward driving rollers 18. This allows a longer conveying surface to be supplied than would be possible if more of the power produced by motor 22 were to be absorbed by the drive member guide system.

In the illustrated embodiment, axis 42 is angled at an angle α toward inside radius side channel 16. This configuration causes drive member 20 to tend to ride upwardly along guide surface 36 thereby biasing drive member 20 against rollers 18. In the illustrated embodiment, the angle α is generally the same as the angle between second surface 34 and a line perpendicular to first surface 32. In the illustrated embodiment, guide members 26 are bearing members.

Endless drive member 20 may be made from a variety of materials including standard reinforced v-belt materials. In the illustrated embodiment, drive member 20 is made substantially from a polymeric material. Examples of such a polymeric material are a urethane, a polyester or the like. An advantage of a drive member made in this fashion is that it can be supplied in any desired length and welded or spliced into a continuous member. This allows conveyors having curved portions that may be provided in significantly greater lengths than those utilizing conventional reinforced belts. Utilizing an endless drive member made from a polymeric material is facilitated by the reduction in friction loss resulting from use of guide system 24. Because guide system 24 reduces friction loss, a lower horsepower motor 22 may be used hence less force is applied to endless drive member 20. This reduces the need for reinforcing members to be formed into the endless drive member and may eliminate it altogether. In the illustrated embodiment, drive member 20 is supplied by BEHA Belt USA and may be spliced using welding tools supplied by the same company. Although the invention is illustrated utilizing a V-shaped drive member, other shapes are possible, including rectangular, circular, or the like.

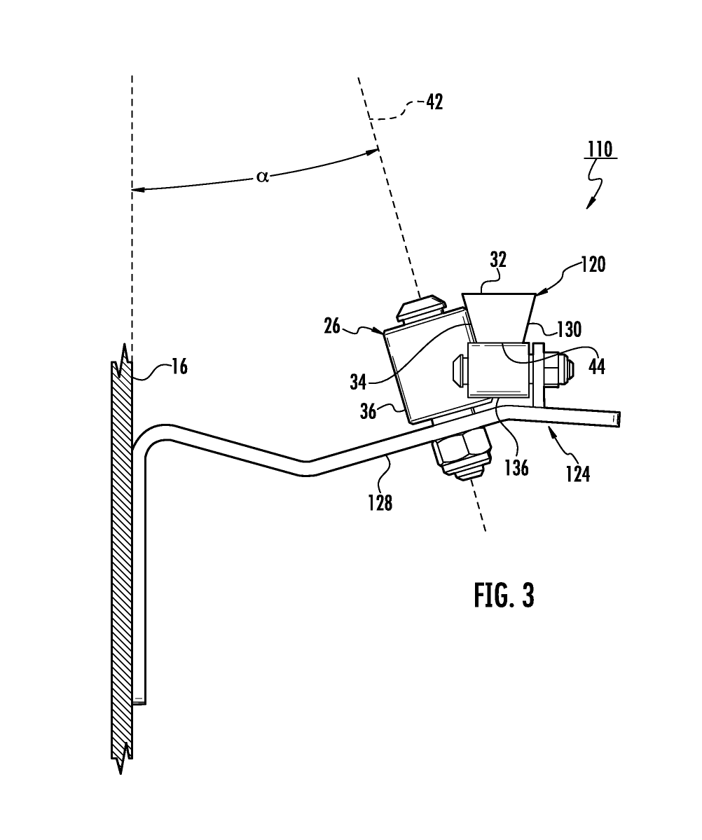

In an alternative embodiment, a conveyor 110 includes an endless drive member 120 in the form of a V-belt and a guide system 124 to guide drive member 120 (FIG. 3). Guide system 124 includes another guide member 136 that cooperates with guide member 26 in guiding drive member 120. Guide member 136 provides support at a lower surface 44 of guide member 26 to assist in maintaining contact with rollers 18. Guide members 136 may be mounted on common bracket 128 with guide member 36 or may be on a separate bracket. There may be a greater or lesser number of guide members 136 than guide members 36.

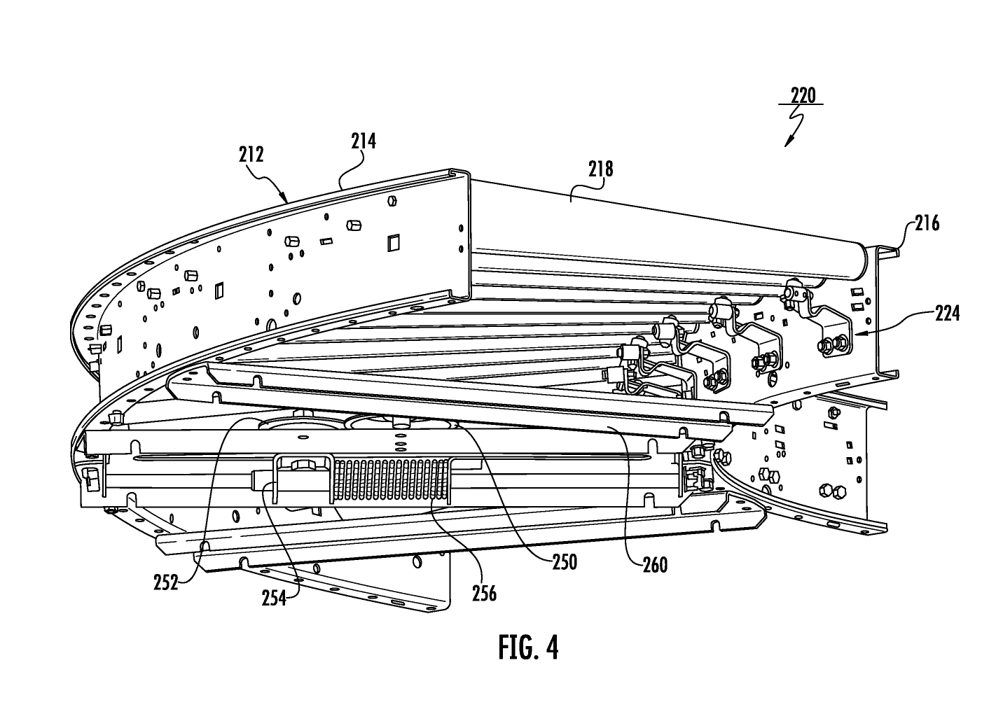

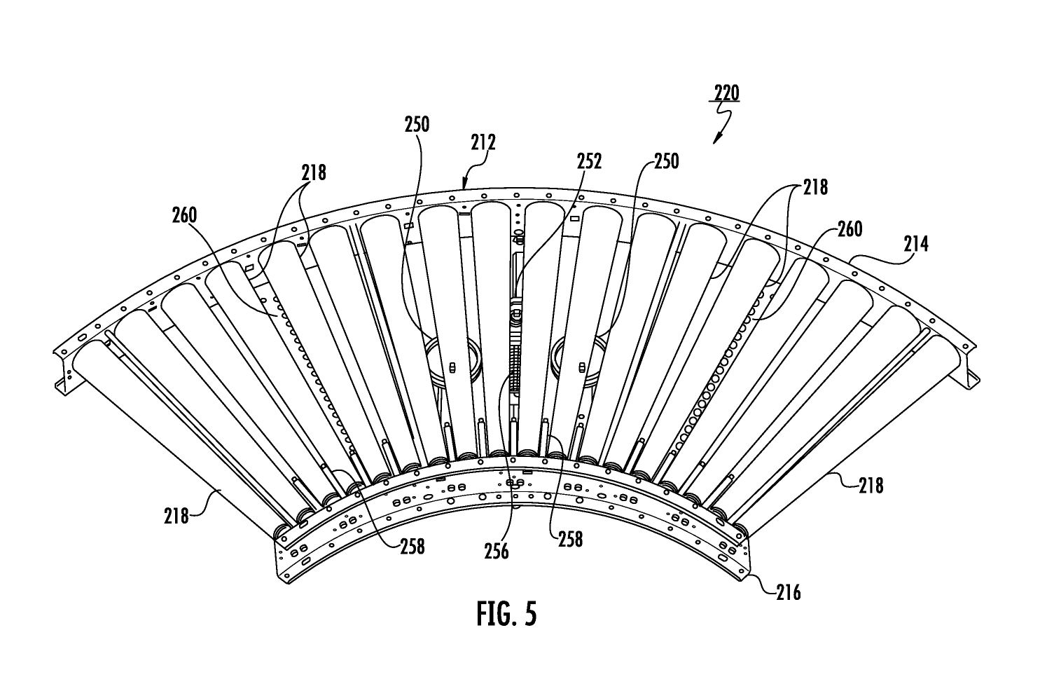

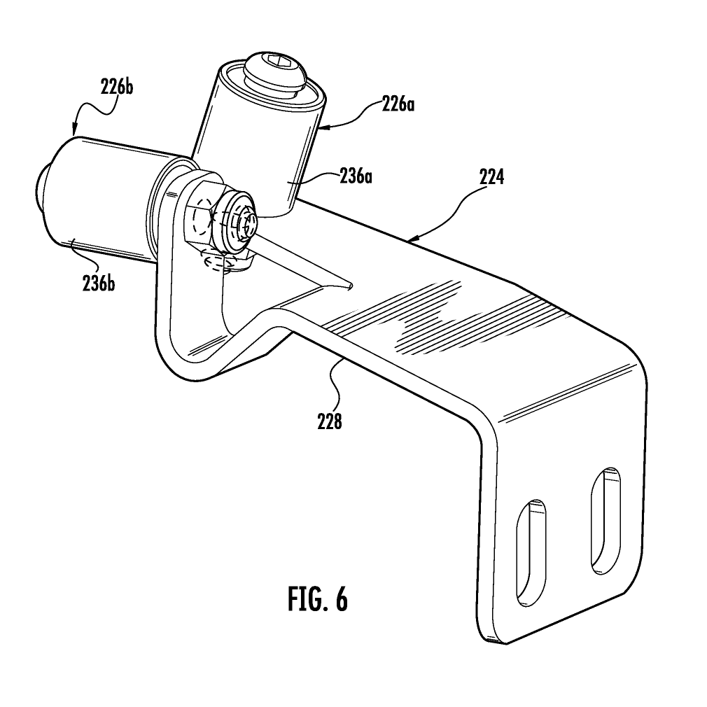

In another alternative embodiment, a conveyor 210 has at least one curved portion 212 (FIGS. 4-6). In the illustrated embodiment, the entire conveyor is curved, which is known as a turn conveyor. However, curved portion 212 may be part of a larger conveyor having straight portions, other curved portions, or the like. Conveyor 210 includes a pair of spaced apart side channels that are curved, including an outside radius curved side channel 214 and an inside radius curved side channel 216. A plurality of freely rotating rollers 218 are supported between side channels 214, 216. An endless drive member (not shown in FIGS. 4-6) that is similar to drive member 20 is provided to drive rollers 218.

A guide system 224 is provided for guiding the drive member. Guide system 224 includes a plurality of guide members 226a, 226b, each of which may be supported by a bracket 228 to inside radius side channel 216. In the illustrated embodiment, brackets 228 provide cantilevered support for guide members 226a, 226b. However, other bracket configurations could be used.

Each guide member 226a, 226b includes a respective guide surface 236a, 236b that provides substantial non-scrubbing engagement with generally planar respective second and third surfaces of the drive member. Each guide member 226a, 226b is in the form of a cylinder having a generally planar outer surface that defines respective guide surface 236a, 236b and which rotates about an axis that is generally parallel to generally planar respective second and third surfaces of the drive member.

Conveyor 210 further includes guide sheaves 250 for guiding the drive member and a tension sheave 252 between the guide sheaves to maintain a constant tension of the guide member. Tension sheave 252 is slideably supported by a slide 254 which is biased outwardly by a biasing member 256. Conveyor 210 further includes finger guards 258 to discourage insertion of operator fingers between rollers 218 at guide system 224. Conveyor system 210 further includes cross members 260 extending between side channels 214, 216 to interconnect the side channels.

While the foregoing description describes several embodiments of the present invention, it will be understood by those skilled in the art that variations and modifications to these embodiments may be made without departing from the spirit and scope of the invention, as defined in the claims below. The present invention encompasses all combinations of various embodiments or aspects of the invention described herein. It is understood that any and all embodiments of the present invention may be taken in conjunction with any other embodiment to describe additional embodiments of the present invention. Furthermore, any elements of an embodiment may be combined with any and all other elements of any of the embodiments to describe additional embodiments.

The embodiments of the invention in which an exclusive property or privilege is claimed are defined as follows:

1. A conveyor having at least one curved portion, said conveyor comprising:
a pair of spaced apart side channels, said side channels being curved at said curved portion;
a plurality of rollers supported between said side channels;
an endless drive member driving said rollers;
a motor propelling said drive member; and
a guide system guiding said drive member, said guide system comprising a plurality of guide members, each of said guide members having a guide surface that provides substantial non-slip engagement with said drive member.

2. The conveyor as claimed in claim 1 wherein said drive member has at least one generally planar surface and said guide surface provides substantially non-slip engagement with said generally planar surface.

3. The conveyor as claimed in claim 2 wherein each of said guide members comprises a cylinder having a generally planar outer surface, said cylinder adapted to rotate about an axis that is generally parallel to said generally planar surface of said drive member.

4. The conveyor as claimed in claim 3 wherein said axis is angled toward an inside radius of said curved portion in the direction of said rollers, thereby biasing said drive member against said rollers.

5. The conveyor as claimed in claim 4 wherein said guide members comprise bearing members.

6. The conveyor as claimed in claim 1 wherein said endless drive member is made substantially from a polymeric material.

7. The conveyor as claimed in claim 6 wherein said polymeric material comprises a urethane.

8. The conveyor as claimed in claim 6 wherein said polymeric material comprises polyester.

9. The conveyor as claimed in claim 1 wherein said drive member comprises a V-shaped belt.

10. The conveyor as claimed in claim 6 wherein said endless drive member is adapted to be spliced.

11. The conveyor as claimed in claim 1 wherein said rollers comprise tapered rollers.

12. The conveyor as claimed in claim 1 including brackets to support said guide members from one of said side channels.

13. The conveyor as claimed in claim 12 wherein said one of said side channels is at said inside radius of said curved portion.

14. The conveyor as claimed in claim 12 wherein said brackets provide cantilevered support for said guide members.

15. A conveyor having at least one curved portion, said conveyor comprising:
a pair of spaced apart side channels, said side channels being curved at said curved portion;
a plurality of rollers supported between said side channels;
an endless drive member driving said rollers;
a motor propelling said drive member; and
a guide system guiding said drive member, said guide system comprising a plurality of guide members engaging said drive member, each of said guide members comprising a rotatable cylindrical member.

16. The conveyor as claimed in claim 15 wherein said drive member comprising a V-shaped belt having a generally planar first surface positioned to engage said rollers and a generally planar second surface extending at an angle from said first surface.

17. The conveyor as claimed in claim 16 wherein said guide member engages said second surface of said drive member.

18. The conveyor as claimed in claim 15 wherein each of said cylindrical members rotate about an axis, said axis being angled toward an inside radius of said curved portion in the direction of said rollers, thereby biasing said drive member against said rollers.

19. The conveyor as claimed in claim 15 wherein said cylindrical members comprise bearing members.

20. The conveyor as claimed in claim 15 wherein said endless drive member is made substantially from a polymeric material.

21. The conveyor as claimed in claim 20 wherein said polymeric material comprises a urethane.

22. The conveyor as claimed in claim 20 wherein said polymeric material comprises polyester.

23. The conveyor as claimed in claim 20 wherein said endless drive member is adapted to be spliced.

24. The conveyor as claimed in claim 15 wherein said drive member comprises a V-shaped belt.

25. The conveyor as claimed in claim 15 wherein said rollers comprise tapered rollers.

26. The conveyor as claimed in claim 15 including brackets to support said guide members from one of said side channels.

27. The conveyor as claimed in claim 26 wherein said one of said side channels is at said inside radius of said curved portion.

28. The conveyor as claimed in claim 26 wherein said brackets provide cantilevered support for said guide members.

29. The conveyor system as claimed in claim 15 including a plurality of other guide members engaging said drive member, said other guide members providing vertical support to said drive member.
